(19) United States
(12) Patent Application Publication
(10) Pub. No.: US 2006/0260312 A1
(43) Pub. Date: Nov. 23, 2006

(54) Method of creating liquid air products with direct compression wind turbine stations

(76) Inventor: Eric Ingersoll, Cambridge, MA (US)

Correspondence Address: HELLER EHRMAN LLP, 275 MIDDLEFIELD ROAD, MENLO PARK, CA, 94025-3506, US

(21) Appl. No.: 11/437,408

(22) Filed: May 19, 2006

Related U.S. Application Data
(63) Continuation-in-part of application No. 10/744,232, filed on Dec. 22, 2003.

(51) Int. Cl. F03G 7/00; F01K 27/00

(52) U.S. Cl. 60/641.1

(57) ABSTRACT

A method of creating liquid gas uses a wind energy system is provided that has a plurality of direct compression wind turbine stations. Direct compression is direct rotational motion of a shaft or a rotor coupled to one or more compressors. Wind energy is collected from the plurality of direct compression wind turbine stations. Compressed air is created with at least a portion of the wind energy. Liquid gas is created with at least a portion of the compressed air.

### RELATED APPLICATIONS

This application is a continuation-in-part of U.S. Ser. No. 10/744,232, filed Dec. 22, 2003, which application is fully incorporated herein by reference.

### BACKGROUND

1. Field of the Invention

This invention relates generally to methods of creating liquid gas, and more particularly to methods of creating liquid gas using a wind energy system that has a plurality of direct compression wind turbine stations.

2. Description of the Related Art

From its commercial beginnings more than twenty years ago, wind energy has achieved rapid growth as a technology for the generation of electricity. The current generation of wind technology is considered mature enough by many of the world's largest economies to allow development of significant electrical power generation. By the end of 2005 more than 59,000 MW of windpower capacity had been installed worldwide, with annual industry growth rates of greater than 25% experienced during the last five years.

Certain constraints to the widespread growth of windpower have been identified. Many of these impediments relate to the fact that in many cases, the greatest wind resources are located far from the major urban or industrial load centers. This means the electrical energy harvested from the areas of abundant wind must be transmitted to areas of great demand, often requiring the transmission of power over long distances.

Transmission and market access constraints can significantly affect the cost of wind energy. Varying and relatively unpredictable wind speeds affect the hour to hour output of wind plants, and thus the ability of power aggregators to purchase wind power, such that costly and/or burdensome requirements can be imposed upon the deliverer of such varying energy. Congestion costs are the costs imposed on generators and customers to reflect the economic realities of congested power lines or “Bottlenecks.” Additionally, interconnection costs based upon peak usage are spread over relatively fewer kwhs from intermittent technologies such as windpower as compared to other technologies.

Power from existing and proposed offshore windplants is usually delivered to the onshore loads after stepping up the voltage for delivery through submarine high voltage cables. The cost of such cables increases with the distance from shore. Alternatives to the high cost of submarine cables are currently being contemplated. As in the case of land-based windplants with distant markets, there will be greatly increased costs as the offshore windpower facility moves farther from the shore and the load centers. In fact, the increase in costs over longer distance may be expected to be significantly higher in the case of offshore windplants. It would thus be advisable to develop alternative technologies allowing for the transmission of distant offshore energy such as produced by windpower.

A need exists, for example, to provide improved methods of making liquid gas. There is a further need for making liquid gas with the use of wind energy systems that have direct compression wind turbine stations.

### SUMMARY

Accordingly, an object of the present invention is to provide an improved method of making liquid gas.

Another object of the present invention is to provide a method of making liquid gas with a wind energy system.

A further object of the present invention is to provide a method of making liquid gas with direct compression wind turbine stations.

These and other objects of the present invention are achieved in a method of creating liquid gas. A wind energy system is provided that has a plurality of direct compression wind turbine stations. Direct compression is direct rotational motion of a shaft or a rotor coupled to one or more compressors. Wind energy is collected from the plurality of direct compression wind turbine stations. Compressed air is created with at least a portion of the wind energy. Liquid gas is created with at least a portion of the compressed air.

### BRIEF DESCRIPTION OF THE DRAWINGS

FIG. 1(a) illustrates one embodiment of a wind energy and storage system of the present invention.

FIG. 1(b) illustrates one embodiment of a wind energy and storage system of the present invention with a multi-stage compressor.

FIG. 2 illustrates one embodiment of a toroidal intersecting vane compressor that can be used with the present invention.

### DETAILED DESCRIPTION

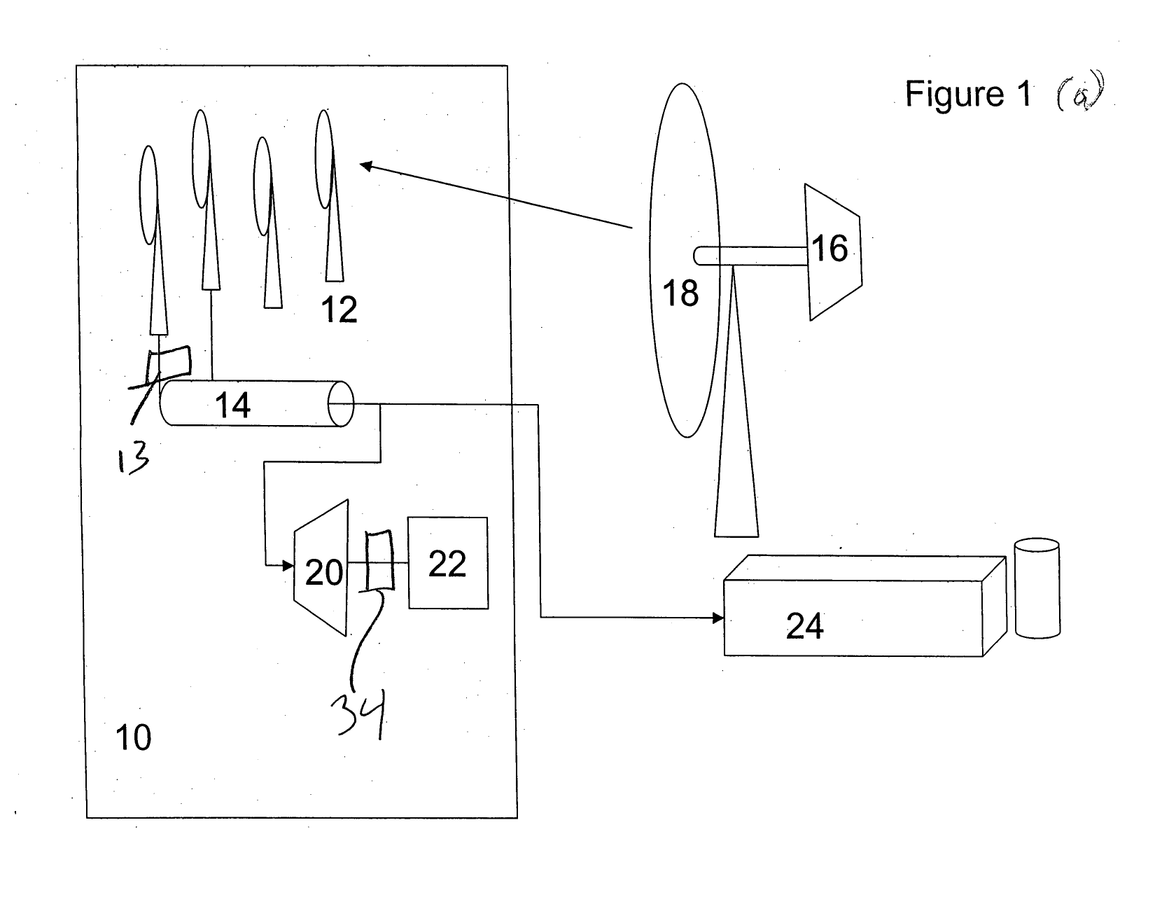

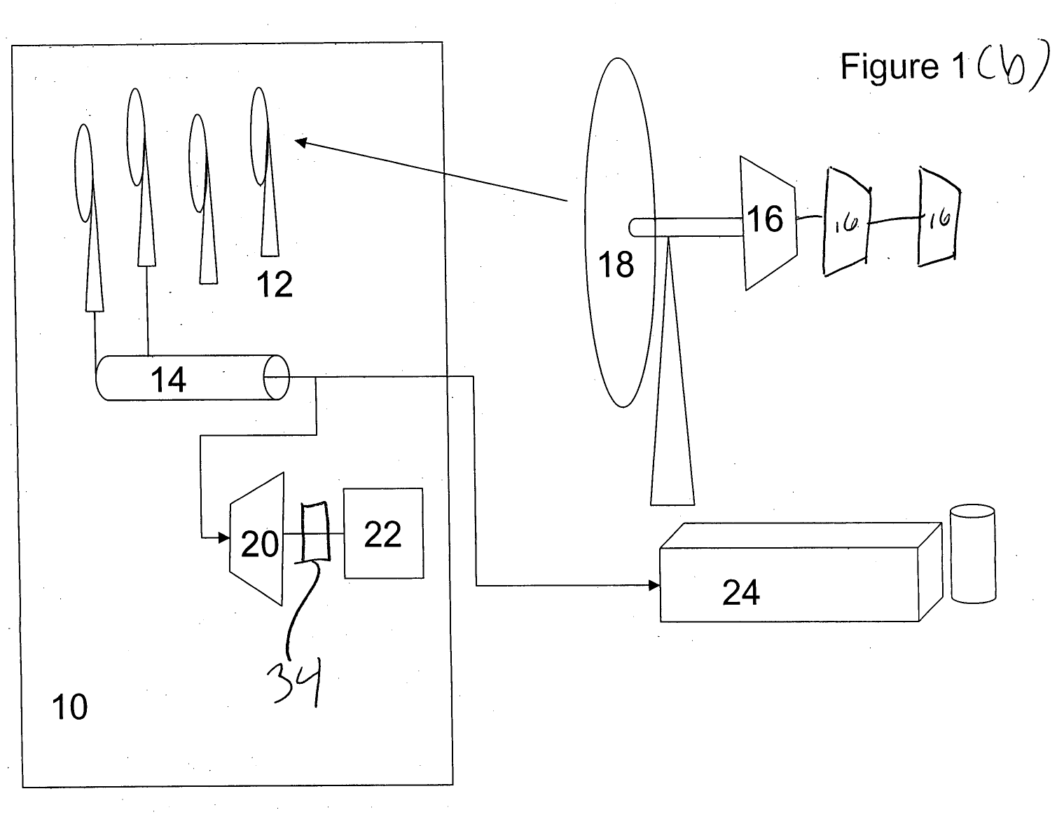

In one embodiment of the present invention, a method is providing for creating liquid gas. A wind energy system 10, FIG. 1(a), is used that has a plurality of direct compression wind turbine stations. Direct compression is direct rotational motion of a shaft or a rotor coupled to one or more compressors. Wind energy is collected from the plurality of direct compression wind turbine stations. Compressed air is created with at least a portion of the wind energy. Liquid gas is created with at least a portion of the compressed air.

The compressed air is stored and then at least a portion of the stored compressed air is subsequently used to make the liquid gas, or the compressed gas is used immediately to make liquid air or gas. The liquid gas is created when the air is compressed, or when the compressed air is cooled through expansion or another refrigeration process. The liquid gas can be created with the use of an integrated compressor and expander. The integrated compressor and expander can share a common shaft.

A phase change of the compressed air is used to create the liquid gas. The liquid gas is selected from, air, a gaseous mixture, any gas that is liquefied in a chemical or industrial process, or any gas used in a refrigeration cycle. The liquid gas is used to make liquid nitrogen, liquid oxygen, liquid argon, liquid or solid CO₂ and the like. The liquid gas may also be used to liquefy any other gas used in a chemical, industrial, or refrigeration process. In one specific embodiment, the liquid gas is used to make at least one of, liquid nitrogen, oxygen, argon, CO₂, and other liquefied gas or fluid.

In one embodiment, at least a portion of the electrical energy, vacuum pressure, compressed air, heat from compression and liquid air or another compressed fluid from the system 10 is dispatchable to a production facility 24.

Suitable production facilities 24 include but are not limited to, an aluminum production facility, a fertilizer, ammonia, or urea production facility, a liquid air product production facility that can be used in manufacturing liquid air, liquid oxygen, liquid nitrogen, and other liquid air products, a fresh water from desalination production facility, a ferrosilicon production facility, an electricity intensive chemical process or manufacturing facility, a tire recycling plant, coal burning facility, biomass burning facility, medical facility, cryogenic cooling process, or any plant that gasifies liquid oxygen, nitrogen, argon, CO₂, an ethanol production facility, a food processing facility. Examples of food processing facilities include but are not limited to, dairy or meat processing facilities and the like.

In one embodiment, electricity provided by the system 10 is used to electrolyze water at the production facility 24. In another embodiment, the system 10 is configured to provide pressure used at the production facility 24 to drive a reverse or forward osmosis process. In another embodiment, the system 10 is configured to provide at least one of vacuum or heat to drive a distillation process at the production facility 24. In one embodiment, the compressor 16 compresses fluid that is evaporating from fluid in a distillation process. In another embodiment, compressed fluid that is evaporating from a distillation process is returned to exchange its heat with liquid in an evaporation or distillation process.

The liquid air can be used to create a flue stream with reduced nitrogen content so that the flue gas can be sequestered at an energy or industrial plant and in one embodiment, the sequestered gas is CO₂. CO₂ can be sequestered by using pressure from the direct compression windfarm to pump the CO₂ underground, or power pumps that will pump the CO₂ underground. The direct compression windfarm can also provide electricity and/or pressure so CO₂ can be electrolyzed to separate carbon from oxygen. Hydrogen and other atoms and molecules can be added to the carbon to create hydrocarbon fuels or products, or other carbon based products.

At least a portion of the wind energy can be used to make electricity for an industrial plant. Thermal energy can be added to an expander at one or more of the following: into an interior of the expander, at an intake to the expander and at an outflow at the expander. The thermal energy added to the expander can be, dry air, humid air, wet steam and dry steam, and other fluid that can transfer thermal energy, and the like. An expander can be provided to expand at least a portion of the wind energy and at least a portion of the thermal energy from the thermal energy system. Suitable expanders include but are not limited to, reciprocating, rotary, roots-blower, single screw, twin screw, or diaphragm expander, natural gas turbine, intersecting vein machine, toroidal intersecting vein machine and the like. The expander is coupled to at least a portion of the plurality of direct compression wind turbine stations to produce electricity. The expander is coupled to a generator, wherein rotational energy of the expander is an input to a generator to make the electricity. In one embodiment, at least a portion of the energy from the wind energy system and the thermal energy system is dispatchable.

The liquid air can be supplied from the windfarm to a customer in many ways: through an insulated pipeline, an insulated storage tank an insulated tanker truck, an insulated rail bar, an insulated vessel on or in a boat, ship, or barge. The liquid air can be provided as liquid air, or as liquid air components such as oxygen, nitrogen, argon and the like. The liquid air can be gasified before it reaches the customer, when it reaches the customer, or sometime after it reaches the customer. The liquid air can or liquid air products can be gasified to pressurized air or pressurized air products, and shipped via high pressure pipelines or high pressure cylinders.

The liquid air or liquid air products can be used for their cooling properties when they are gasified, or their chemical properties, or both.

The manufacture of liquid air products may enable the construction of direct compression wind turbine farms in locations that have little or no transmission access to the electric grid, allowing wind energy to be harvested, stored, transmitted, and used in a form other than as electricity, enabling this form of energy to be transmitted by truck, boat, rail, and other means.

The liquid air products may be made on location for some customers at their places of business, or may be shipped to them.

The liquid air products may be made on shore or offshore. Liquid air may have certain advantages in transmitting energy over electricity or compressed fluids, including cheaper transmission costs. For example, liquid air takes up 80 times less space than 80 barr air, enabling storage of similar amounts of energy in much smaller pipes or vessels, thus reducing costs. Also, for example, it may be cheaper to lay liquid air pipe from an offshore location to 1 and than it is to lay marine electrical cable or high pressure pipe.

The delivery of wind energy can be coordinated and stabilized. An energy delivery schedule can be created from the wind energy system in response to predictions for wind speed, wind power availability levels, historical, current and anticipated power and green energy prices, and historical, current and anticipated transmission availability. The delivery schedule can be used to match a customer's anticipated demand. The delivery schedule can manage updates and corrections to schedules on very short notice. The delivery schedule can be used to set a reduced number of constant power output periods during an upcoming period of time. By way of illustration, during the upcoming period of time energy, delivery levels can remain substantially constant despite fluctuations and oscillations in wind speed and wind power availability levels.

The upcoming period of time can be any period of time such as the next 24-hour period. In one embodiment, no more than seven constant power output periods during any given 24-hour period would be scheduled. The delivery schedule can take into account the amount of energy that can be supplied directly from the wind power system as well as stored energy. In one embodiment, the delivery schedule is utilized to determine an amount of energy that can be provided from storage, and an amount of power expected to be used and withdrawn by a power grid. In another embodiment, the delivery schedule is utilized to assist in ensuring that wind energy is available at constant power output levels even when the wind energy availability levels drop below a demand for power needed by a power grid.

In another embodiment, at least one demand history is created for a location to help forecast and predict how much energy will be used at the location during an upcoming period of time. Energy availability from the wind energy system can be determined. The demand history can be used for delivery of wind energy to the location. The demand history can be used for delivery of wind energy to the location to manage load, offset spikes, sags, and surges, and meet the needs of the grid and the customer.

The wind energy system can be coupled to a power grid that can be accessed to supply energy into storage by using electricity to run the generator/expanders backwards as motor/compressors to pressurize the system, which will then be expanded on demand to make electricity.

An energy usage schedule can be developed using forecasts and predictions to for the upcoming time period to determine how energy from storage should be used to achieve a desired cost savings. A demand charge can be determined that may be applied based on spikes or surges that can occur during the upcoming time period, and an energy usage schedule then developed to reduce and/or offset the spikes or surges in a manner that achieves cost savings at a location. The location can be a commercial property end-user of energy and storage of energy is used to lower overall costs of energy at the commercial property end-use, and the like.

In one embodiment, an estimated cost savings for the upcoming time period is determined, and then that determination is repeated for an extended period of time, to help determine an overall cost savings that can be achieved during the extended period of time.

Referring to FIG. 1, one embodiment of the present invention is a wind energy generating and storage system, generally denoted as 10. A plurality of direct compression wind turbine stations 12 are provided. An intercooler 13 can be provided. Direct compression is direct rotational motion of a shaft or a rotor coupled to one or more compressors 16. A storage device 14 is coupled to at least a portion of the wind turbine stations 12. At least a first toroidal intersecting vane compressor 16 is coupled to the storage device to compress or liquefy air. The compressor 16 has a fluid intake opening and a fluid exhaust opening. Rotation of a turbine 18 drives the compressor 16. At least one expander 20 is configured to release compressed or liquid air from the storage device 14. A generator 22 is configured to convert the compressed or liquid air energy into electrical energy.

In one embodiment the system 10 has a power to weight ratio greater than 1 megawatt/15 tons. The compressor 16 is much lighter, and therefore less expensive than the generator 22 and gearbox it replaces. The best power-to-weight machine in current widescale commercial use is the Vestas 3 MW machine, which has a nacelle weight of 64 tons.

In another embodiment, illustrated in FIG. 1(b), a first multi-stage compressor 16 is coupled to the storage device 14 to compress air. In another embodiment, a pressure of compressed air in the storage device 14 is greater than 8 barr. The cost efficiency of storing compressed air in pipe changes dramatically with high pressure pipe and high pressure compressors 16. For relatively little extra cost, storage can increase an order of magnitude. 80 barr air holds ten times the energy storage of 8 barr air.

In one embodiment of the present invention, a method of production collects and stores wind energy from a plurality of direct compression wind turbine stations 12. Air is compressed or liquefied air is formed from the wind energy utilizing a toroidal intersecting vane compressor 16. An expander 20 is used to release compressed or liquid air. An absorber is introduced to the compressed or liquid air for pressure swing absorption. The absorber is used for air separation into oxygen or nitrogen, argon, and other air products. In one embodiment, the absorber absorbs at a higher pressure and desorbs at a lower pressure.

In one embodiment, electricity provided by the system 10 is used to electrolyze water at the production facility 24. In another embodiment, the system 10 is configured to provide pressure used at the production facility 24 to drive a reverse or forward osmosis process. In another embodiment, the system 10 is configured to provide at least one of vacuum or heat to drive a distillation process at the production facility 24.

The production or processing facility 24 can be co-located with the system 10.

In one embodiment, the system 10 is configured to receive waste heat from the production facility 24 and utilize at least a portion of the waste heat to provide the electrical energy that is dispatched to the production facility 24. By way of illustration, and without limitation, the system 10 provides electricity for the reduction of carbon dioxide or water and can pressurize carbon dioxide to provide power to electrolyze the carbon dioxide to separate carbon from oxygen. The system 10 can be used to pressurize carbon dioxide and water to a supercritical state and provide power for reaction of these components to methanol. Hydrogen can be introduced to the carbon to create hydrocarbon fuels. The oxygen can be utilized to oxy-fire coal, process iron ore, burn cole, process iron ore and the like.

The system 10 can be used to provide a vacuum directly to the production facility 24. This could assist, for example, in the production of products at low temperature distillation facilities, such as fresh water at desalination plants.

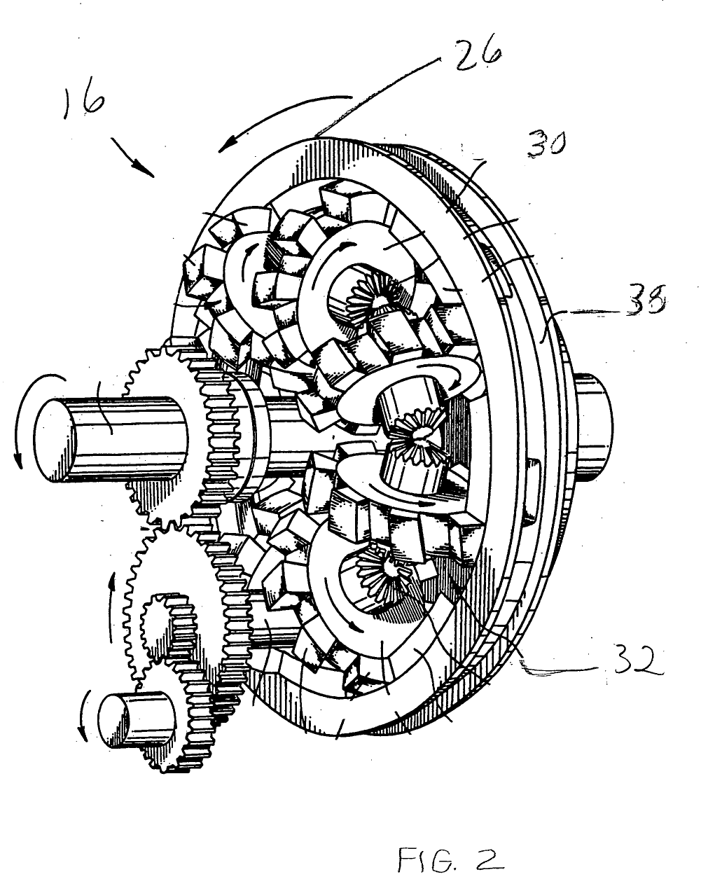

By way of illustration, and without limitation, as shown in FIGS. 2(a) and 2(b) the toroidal intersecting vane compressor 16 includes a supporting structure 26, a first and second intersecting rotors 28 and 30 rotatably mounted in the supporting structure 26. The first rotor 28 has a plurality of primary vanes positioned in spaced relationship on a radially inner peripheral surface of the first rotor 28. The radially inner peripheral surface of the first rotor 28 and a radially inner peripheral surface of each of the primary vanes can be transversely concave, with spaces between the primary vanes and the inside surface to define a plurality of primary chambers 32. The second rotor 30 has a plurality of secondary vanes positioned in spaced relationship on a radially outer peripheral surface of the second rotor. The radially outer peripheral surface of the second rotor 30 and a radially outer peripheral surface of each of the secondary vanes can be transversely convex. Spaces between the secondary vanes and the inside surface define a plurality of secondary chambers 32. A first axis of rotation of the first rotor 28 and a second axis of rotation of the second rotor 30 are arranged so that the axes of rotation do not intersect. The first rotor 28, second rotor 30, primary vanes and secondary vanes are arranged so that the primary vanes and the secondary vanes intersect at only one location during their rotation. The toroidal intersecting vane compressor 16 can be self-synchronizing.

In one embodiment, the turbine 18 is configured to power the compressor(s) 16. For example, the turbine 18 can drive the compressor 16 by a friction wheel drive which is frictionally connected to the turbine 18 and is connected by a belt, a chain, or directly to a drive shaft or gear of the compressor 16. The compressed air can be heated or cooled. The compressed air can be heated or cooled while maintaining substantially constant volume. The compressed air can be heated or cooled while maintaining substantially constant pressure. The compressed air can be heated or cooled by a heat source selected from at least one of the following: solar, ocean, river, pond, lake, other sources of water, power plant effluent, industrial process effluent, combustion, nuclear, and geothermal energy.

The expander 20 can operate independently of the turbine 18 and the compressor 16. The expander 20 and compressor 16 can be approximately the same or different sizes.

A heat exchanger 34 can be provided and coupled to an expander exhaust opening. At least a portion of the compressed air energy can be used as a coolant.

In one specific embodiment, a rotatable turbine 18 is mounted to a mast. In one embodiment, as mentioned above, a toroidal intersecting vane compressor (TIVC) 16 is used. The TIVC is characterized by a fluid intake opening and a fluid exhaust opening, wherein the rotation of the turbine 18 drives the compressor 16. The system 10 permits good to excellent control over the hours of electrical power generation, thereby maximizing the commercial opportunity and meeting the public need during hours of high or peak usage. Additionally, the system 10 minimizes and can avoid the need to place an electrical generator 22 off-shore. The system 10 allows for an alternative method for transmission of power over long distance. Further, the system 10 can be operated with good to excellent efficiency rates.

In one embodiment, a generator apparatus 22 includes, (a) a rotatable turbine 18 mounted to a mast, (b) at least one toroidal intersecting vane compressor 16 characterized by a fluid intake opening and a fluid exhaust opening, wherein the rotation of the turbine 18 drives the compressor 16; (c) a conduit having a proximal end and a distal end wherein the proximal end is attached to the fluid exhaust opening; (d) at least one toroidal intersecting vane expander 20 characterized by a fluid intake opening attached to the distal end; (e) an electrical generator 22 operably attached to the expander 20 to convert rotational energy into electrical energy, and to connect the generator 22 to one or more customers or the electric grid to sell the electricity.

The turbine 18 can be powered to rotate by a number of means apparent to the person of skill in the art. One example is air flow, such as is created by wind. In this embodiment, the turbine 18 can be a wind turbine, such as those well known in the art. One example of a wind turbine is found in U.S. Pat. No. 6,270,308, which is incorporated herein by reference. Because wind velocities are particularly reliable off shore, the turbine 18 can be configured to stand or float off shore, as is known in the art. In yet another embodiment, the turbine 18 can be powered to rotate by water flow, such as is generated by a river or a dam.

As mentioned above, the compressor 16 is preferably a toroidal intersecting vane compressor 16, such as those described in Chomyszak U.S. Pat. No. 5,233,954, issued Aug. 10, 1993 and Tomcyzk, U.S. patent application Publication No. 2003/0111040, published Jun. 19, 2003. The contents of the patent and publication are incorporated herein by reference in their entirety. In a particularly preferred embodiment, the toroidal intersecting vane compressor 16 and elements of the system 10, are found in U.S. Publications Nos. 2005132999, 2005133000 and 20055232801, each incorporated herein fully by reference.

In one embodiment, two or more toroidal intersecting vane compressors 16 are utilized. The compressors 16 can be configured in series or in parallel and/or can each be single stage or multistage compressors 16. The compressor 16 will generally compress air, however, other environments or applications may allow other compressible fluids to be used.

The air exiting the compressor 16 through the compressor exhaust opening will directly or indirectly full a conduit. Multiple turbines 18, and their associated compressors 16, can full the same or different conduits. For example, a single conduit can receive the compressed air from an entire wind turbine farm, windplant or windpower facility. Alternatively or additionally, the “wind turbine farm” or, the turbines 18 therein, can full multiple conduits. The conduit(s) can be used to collect, store, and/or transmit the compressed fluid, or air. Depending upon the volume of the conduit, large volumes of compressed air can be stored and transmitted. The conduit can direct the air flow to a storage vessel or tank or directly to the expander 20. The conduit is preferably made of a material that can withstand high pressures, such as those generated by the compressors 16. Further, the conduit should be manufactured out of a material appropriate to withstand the environmental stresses. For example, where the wind turbine 18 is located off shore, the conduit should be made of a material that will withstand seawater, such as pipelines that are used in the natural gas industry.

The compressed air can be heated or cooled in the conduit or in a slip, or side, stream off the conduit or in a storage vessel or tank. Cooling the fluid can have advantages in multi-stage compressing. Heating the fluid can have the advantage of increasing the energy stored within the fluid, prior to subjecting it to an expander 20. The compressed air can be subjected to a constant volume or constant pressure heating or cooling. The source of heating can be passive or active. For example, sources of heat include solar, ocean, river, pond, lake, other sources of water, power plant effluent, industrial process effluent, combustion, nuclear, and geothermal energy. The conduit, or compressed air, can be passed through a heat exchanger to cool waste heat, such as can be found in power plant streams and effluents and industrial process streams and effluents (e.g., liquid and gas waste streams). In yet another embodiment, the compressed air can be heated via combustion.

Like the TIVC, the expander 20 is preferably a toroidal intersecting vane expander 20 (TIVE), such as those described by Chomyszak, referenced above. Thus, the toroidal intersecting vane expander 20 can comprise a supporting structure, a first and second intersecting rotors rotatably mounted in the supporting structure, the first rotor having a plurality of primary vanes positioned in spaced relationship on a radially inner peripheral surface of the first rotor with the radially inner peripheral surface of the first rotor and a radially inner peripheral surface of each of the primary vanes being transversely concave, with spaces between the primary vanes and the inside surface defining a plurality of primary chambers, the second rotor having a plurality of secondary vanes positioned in spaced relationship on a radially outer peripheral surface of the second rotor with the radially outer peripheral surface of the second rotor and a radially outer peripheral surface of each of the secondary vanes being transversely convex, with spaces between the secondary vanes and the inside surface defining a plurality of secondary chambers, with a first axis of rotation of the first rotor and a second axis of rotation of the second rotor arranged so that the axes of rotation do not intersect, the first rotor, the second rotor, primary vanes and secondary vanes being arranged so that the primary vanes and the secondary vanes intersect at only one location during their rotation. Similarly, the toroidal intersecting vane expander 20 is self-synchronizing. Like the TIVC, the expanders 20 can be multistage or single stage, used alone, in series or in parallel with additional TIVEs. A single TIVE can service a single conduit or multiple conduits.

One of the advantages of the present invention is the ability to collect the compressed air or other fluid and convert the compressed air or fluid to electricity independently of each other. As such, the electricity generation can be accomplished at a different time and in a shorter, or longer, time period, as desired, such as during periods of high power demand or when the price of the energy is at its highest.

As such, the expander 20 is preferably configured to operate independently of the turbine 18 and compressor 16. Further, because the conduit that is directing the compressed fluid, or air, to the expander 20 can be of a very large volume, the expander 20 need not be located proximally with the turbine 18 and compressor 16. As such, even where the wind turbine 18 is located off shore, the expander 20 can be located on 1 and, such as at a power plant, thereby avoiding the need to transmit electricity from the wind farm to the grid or customer.

Further, the sizes and capacities of the TIVCs and TIVEs can be approximately the same or different. The capacity of the TIVE is preferably at least 0.5 times the capacity of the TIVCs it services, preferably the capacity of the TIVE exceeds the capacity of the TIVCs it services. Generally, the capacity of the TIVE is between about 1 and 5 times the capacity of the TIVCs it serves. For example, if 100 turbines 18, with 100 TIVCs, each have a capacity of 2 megawatts, a TIVE that services all 100 turbines 18, preferably has the capacity to produce 100 megawatts, preferably at least about 200 to 1,000 megawatts. Of course, TIVEs and TIVCs of a wide range of capacities can be designed.

Additional modifications to further improve energy usage can be envisioned from the apparatus of the invention. Energy recycle streams and strategies can be easily incorporated into the apparatus. For example, the expanded fluid exiting from the expander 20 will generally be cold. This fluid can be efficiently used as a coolant, such as in a heat exchanger.

The dimensions and ranges herein are set forth solely for the purpose of illustrating typical device dimensions. The actual dimensions of a device constructed according to the principles of the present invention may obviously vary outside of the listed ranges without departing from those basic principles.

Further, it should be apparent to those skilled in the art that various changes in form and details of the invention as shown and described may be made. It is intended that such changes be included within the spirit and scope of the claims appended hereto.

1. A method of creating liquid gas, comprising:
providing a wind energy system with a plurality of direct compression wind turbine stations, wherein direct compression is direct rotational motion of a shaft or a rotor coupled to one or more compressors;
collecting wind energy from the plurality of direct compression wind turbine stations;
creating compressed air with at least a portion of the wind energy; and
creating liquid gas with at least a portion of the compressed air.

2. The method of claim 1, further comprising:
operating a compressor at a pressure of 10 to 100 atmospheres at a fluid exhaust opening.

3. The method of claim 1, further comprising:
operating a compressor at a pressure of about 10 to 80 atmospheres at a fluid exhaust opening.

4. The method of claim 1, further comprising:
operating a compressor at a pressure of about 20 to 100 atmospheres at a fluid exhaust opening.

5. The method of claim 1, further comprising:
operating a compressor with a minimum operating pressure for power storage of at least 20 atmospheres.

6. The method of claim 1, further comprising:
operating a compressor that has a peak pressure to low pressure ratio of about 10/1.

7. The method of claim 1, further comprising:
operating a compressor that has a peak pressure to low pressure ratio of about 5/1.

8. The method of claim 1, wherein the compressed air is stored and at least a portion of the stored compressed air is subsequently used to make the liquid gas.

9. The method of claim 1, wherein the liquid gas is created when the air is compressed, or when the compressed air is cooled and liquefied through expansion or another refrigeration process.

10. The method of claim 9, wherein the compressed air is dried or dehumidified before it is liquefied.

11. The method of claim 9, wherein the liquid gas is created with the use of an integrated compressor and expander.

12. The method of claim 11, wherein the integrated compressor and expander share a common shaft.

13. The method of claim 1, wherein a phase change of the compressed air is used to create the liquid gas.

14. The method of claim 1, wherein the liquid gas is selected from, air, a gaseous mixture, any gas that is liquefied in a chemical or industrial process, and a gas used in a refrigeration cycle.

15. The method of claim 1, wherein the liquid gas is used to make at least one of, liquid nitrogen, oxygen, argon, CO₂, and other liquefied gas or fluid.

16. The method of claim 1, wherein the liquid gas is used to create a flue stream with reduced nitrogen content.

17. The method of claim 16, wherein the flue steam can be sequestered or utilized at an energy or industrial plant.

18. The method of claim 1, wherein the liquid gas is used at a production facility.

19. The method of claim 16, wherein the sequestered gas is CO₂.

20. The method of claim 19, wherein the CO₂ is sequestered using pressure from the direct compression wind turbine stations to pump the CO₂ underground, or power pumps that will pump the CO₂ underground.

21. The method of claim 1, further comprising:
using the wind energy system to provide electricity or pressure to separate carbon and oxygen from CO₂.

22. The system of claim 21, wherein the CO₂ is electrolyzed.

23. The method if claim 21, further comprising:
adding molecules or atoms to the carbon to create hydrocarbon fuels or products, or other carbon based products.

24. The method of claim 23, wherein hydrogen is added to the carbon.

25. The method of claim 16, wherein the industrial plant is selected from a, sewage treatment facility, water treatment facility, tire recycling plant, coal burining facility, biomass burning facility, medical facility, cryogenic cooling process facility, and a plant that gasifies a fluid.

26. The method of claim 17, wherein the production facility is selected from at least one of, an aluminum production facility, a fertilizer, ammonia, or urea production facility, a liquid air product production facility that can be used in manufacturing liquid air, liquid oxygen, liquid nitrogen, and other liquid air products, a fresh water from desalination production facility, a ferrosilicon production facility, an electricity intensive chemical process or manufacturing facility, a tire recycling plant, coal burning facility, biomass burning facility, medical facility, cryogenic cooling process, or any plant that gasifies liquid oxygen, nitrogen, argon, CO₂, an ethanol production facility and a food processing facility.

27. The method of claim 26, wherein the fluid is selected from, liquid oxygen, nitrogen, argon and CO2.

28. The method of claim 16, expanding at least a portion of the wind energy is used to make electricity for the industrial plant.

29. The method of claim 20, wherein thermal energy is added to the expander at one of, into an interior of the expander, at an intake to the expander and at an outflow at the expander.

30. The method of claim 29, wherein the thermal energy added to the expander is selected from, dry air, humid air, wet steam and dry steam.

31. The method of claim 8, wherein an expander is provided to expand at least a portion of the wind energy and at least a portion of thermal energy from the thermal energy system.

32. The method of claim 20, wherein the expander is selected from a, pivim reciprocating, rotary, roots-blower, singe screw, twin screw, diaphragm, natural gas turbine, intersecting vein machine and toroidal intersecting vein machine.

33. The method of claim 20, wherein the expander is coupled to at least a portion of the plurality of direct compression wind turbine stations to produce electricity.

34. The method of claim 33, further comprising:
producing electricity for a customer or the open market.

35. The method of claim 34, wherein the expander is coupled to a generator, wherein rotational energy of the expander is an input to a generator to make the electricity.

36. The method of claim 35, wherein at least a portion of the electricity is available for sale on the open market.

37. The method of claim 34, wherein the renewable energy credits are associated with the electricity produced.

38. The method of claim 8, wherein the renewable energy credits are associated with electricity produced from the wind energy system and the thermal energy system.

39. The method of claim 1, wherein green credits are provided for the production of electricity from the wind energy system.

40. The method of claim 1, wherein green credits are provided for the production of electricity from the wind energy system and at least a portion of energy from the thermal energy system.

41. The method of claim 1, wherein at least a portion of the energy from the wind energy system and the thermal energy system is dispatchable.

42. The method of claim 34, wherein the renewable energy credits have a value associated with a location of the wind energy system.

43. The method of claim 34, wherein the renewable energy credits are associated with a value placed on the produced electricity.

44. The method of claim 34, wherein the renewable energy credits are sold to third parties through a broker, a sales organization, an auction, directly from the wind energy system, and from a contracted owner of the renewable energy credit

45. The method of claim 8, wherein the renewable energy credits attributed to wind power receive green energy credit.

46. The method of claim 45, wherein those renewable energy credits attributed to the thermal energy system that have attributes which qualify them as green energy credits, also receive green energy credits.

47. The method of claim 8 further comprising:
utilizing at least a portion of the wind power to convert at least a portion of the thermal energy to electricity to increase efficiency of conversion.

48. The method of claim 47, wherein a green energy credit of the thermal energy is increased in response to utilizing the wind power to covert the thermal energy electricity.

49. The method of claim 1, further comprising:
coordinating and stabilizing the delivery of wind energy.

50. The method of claim 1, further comprising:
creating an energy delivery schedule in response to predictions for at least one of, wind speed, wind power availability levels, historical power levels or prices, current power levels or prices, anticipated power levels or prices, green energy prices, historical transmission availability, current transmission availability and anticipated transmission availability.

51. The method of claim 50, wherein the delivery schedule can be used to match a customer's anticipated demand.

52. The method of claim 50, wherein the delivery schedule can manage updates and corrections to schedules on a short notice.

53. The method of claim 50, further comprising:
using the delivery schedule to set a reduced number of constant power output periods during an upcoming period of time.

54. The method of claim 53, wherein during the upcoming period of time energy delivery levels can remain substantially constant despite fluctuations and oscillations in wind speed and wind power availability levels.

55. The method of claim 53, wherein the upcoming period of time is the next 24 hour period.

56. The method of claim 55, further comprising:
setting no more than seven constant power output periods during any given 24 hour period.

57. The method of claim 50, wherein the delivery schedule takes into account the amount of energy that can be supplied directly from the wind power system as well as stored energy.

58. The method of claim 50, wherein the delivery schedule is utilized to determine an amount of energy that can be provided from storage, and an amount of power expected to be used and withdrawn by a power grid.

59. The method of claim 50, wherein the delivery schedule is utilized to assist in ensuring that wind energy is available at constant power output levels even when the wind energy availability levels drop below a demand for power needed by a power grid.

60. The method of claim 1, further comprising:
creating at least one demand history for a location to help forecast and predict how much energy will be used at the location during an upcoming period of time.

61. The method of claim 60, further comprising:
determining when energy will be available from the wind energy system.

62. The method of claim 40, further comprising:
using the demand history for delivery of wind energy to the location.

63. The method of claim 41, further comprising:
using the demand history for delivery of wind energy to the location to offset spikes or surges at the location.

64. The method of claim 60, wherein the wind energy system is coupled to a power grid that can be accessed to supply energy into storage.

65. The method of claim 1, further comprising:
using forecasts and predictions to develop an energy usage schedule for the upcoming time period to determine how energy from storage should be used to achieve a desired cost savings.

66. The method of claim 60, further comprising:
determining a demand charge that may be applied based on sags, spikes or surges that can occur during the upcoming time period and developing an energy usage schedule to reduce and/or offset the spikes or surges in a manner that achieves cost savings.

67. The method of claim 60, wherein the location is a commercial property end-user of energy and storage of energy is used to lower overall costs of energy at the commercial property end-use.

68. The method of claim 60, wherein an estimated cost savings for the upcoming time period is determined, and then that determination is repeated for an extended period of time, to help determine an overall cost savings that can be achieved during the extended period of time.

69. The method of claim 60, wherein the thermal portion of the wind energy can be stored, managed, and enhanced by a solar thermal collector, thermal inertial mass, thin walled tubing with antifreeze distributed inside the tank, fossil fuel burner, a circulation device for using hot air, and the like.

70. The method of claim 60, wherein an energy storage system is provided that is configured to use cold air from a turbo-expander for cooling and/or refrigeration purposes at the location.
